(19) United States
(12) Patent Application Publication
(10) Pub. No.: US 2023/0069018 A1
(43) Pub. Date: Mar. 2, 2023

(54) IMAGE PROCESSING APPARATUS, IMAGING APPARATUS, IMAGE PROCESSING SYSTEM, IMAGE PROCESSING METHOD, AND NON-TRANSITORY COMPUTER READABLE MEDIUM

(71) Applicant: NEC Corporation, Minato-ku, Tokyo (JP)

(72) Inventor: Takahiro SHIROSHIMA, Tokyo (JP)

(73) Assignee: NEC Corporation, Minato-ku, Tokyo (JP)

(21) Appl. No.: 17/798,381

(22) PCT Filed: Dec. 23, 2020
(86) PCT No.: PCT/JP2020/048076

§ 371 Date: Aug. 9, 2022

(30) Foreign Application Priority Data
Feb. 26, 2020 (JP) 2020-030451

(51) Int. Cl. H04N 5/232; G06T 7/00

(52) U.S. Cl. CPC H04N 5/23229; G06T 7/0002; G06T 2207/30168; G06T 2207/10016

(57) ABSTRACT

An image processing apparatus includes a conversion unit for converting moving image data generated in an imaging apparatus into a plurality of still image data pieces, an image quality calculation unit for calculating an image quality of each still image represented by one of the plurality of still image data pieces, and a selection unit for selecting a still image data piece for image processing to be used for image processing. The selection unit selects still image data pieces satisfying a reference quality as the still image data piece(s) for image processing from among the plurality of still image data pieces arranged in an order of captured time if it is determined that a rotation angle of the imaging apparatus when the first still image data piece included in the plurality of still image data pieces is captured exceeds a designated angle.

### TECHNICAL FIELD

The present disclosure relates to an image processing apparatus, an imaging apparatus, an image processing system, an image processing method, and a program.

### BACKGROUND ART

In recent years, services based on the assumption that robots move autonomously have become widespread. For a robot to move autonomously, it is necessary for the robot to recognize a surrounding environment and estimate its own position with high accuracy. Therefore, VSLAM (Visual Simultaneous Localization and Mapping), which generates a map of the surrounding environment from videos captured by the robot and simultaneously estimates a position of the robot, is being studied. In general VSLAM, the captured points that are common in a plurality of videos is recognized as feature points, the position of the camera that has captured them is estimated from the difference between the feature points of the respective images, and the position of the camera is recognized as the position of the robot. Since such VSLAM requires immediate processing, there is no time to perform detailed calculation, and an error occurs between the actual position of the robot and the position estimated by the VSLAM. This error is accumulated as an accumulation error as the time elapses, resulting in a larger error. In the general VSLAM, the camera position is relatively estimated from movements of the feature points in an initially input video. Therefore, the ratio (scale) of a distance of the movement of the estimated camera position to a distance of the movement of the actual camera position is not constant, and there is a difference between the position in the VSLAM and the actual position. Here, a mechanism using a map generated in advance is used as a mechanism for correcting the camera position in the VSLAM having an indefinite scale and an accumulation error. In Patent Literature 1, the feature points of the map constructed in advance are matched with the feature points of the current image to calculate a relative posture of the current image. SfM (Structure from Motion) is used as means for generating a map in advance from such an image. With SfM, all feature points of a series of already acquired two-dimensional images (or frames) are calculated, and matching feature points are estimated from a plurality of temporally successive images. Further, with SfM, the three-dimensional position of the camera which has captured each frame is estimated with high accuracy based on the difference between the positions on the two-dimensional planes in the frames in which the feature points appear.

Generally, a processing time when SfM is executed depends on the number of images to be processed. Specifically, the processing time increases in proportion to the square of the increased number of images to be processed. Therefore, it is desired to reduce the number of images to be processed when SfM is executed. However, as described above, the three-dimensional position of the feature point can be estimated only when the feature points are captured in a plurality of images and the feature points are moved between the images. Thus, the three-dimensional position cannot be estimated when the number of images to be processed is reduced to a certain extent or more.

Patent Literature 2 discloses a configuration of an information processing apparatus for selecting an image suitable for generating three-dimensional data from among a plurality of images captured by using a camera. The information processing apparatus of Patent Literature 2 performs an evaluation by using the number of feature points and the positions of the feature points included in the image, and selects an image according to a result of the evaluation.

### CITATION LIST

### Patent Literature

Patent Literature 1: Japanese Unexamined Patent Application Publication No.
Patent Literature 2: Japanese Unexamined Patent Application Publication No. 2009-237848

### SUMMARY OF INVENTION

### Technical Problem

In processing for selecting images in Patent Literature 2, processing for detecting feature points, the processing for calculating the three-dimensional positions of the feature points, the processing for calculating the position and posture of the camera, and the like are executed on a plurality of images before the image used for the SfM is selected. Further, in the image selection processing in Patent Literature 1, processing is also executed to trace the feature points common to the plurality of frames and identify the trajectories of the feature points. Since such processing includes the processing for analyzing the feature points, substantially the same load as that of the processing performed in the SfM is applied. Therefore, even if an image to be used in the SfM is selected from among a plurality of images and the number of images to be used in the SfM is reduced, a processing load in the image selection processing is increased. As a result, there is a problem that the processing load involved in the SfM is not substantially reduced even when the image selection processing in Patent Literature 1 is used.

An object of the present disclosure is to provide an image processing apparatus, an imaging apparatus, an image processing system, an image processing method, and a program for reducing a processing load involved in SfM.

### Solution to Problem

An image processing apparatus according to a first example aspect includes: a conversion unit configured to convert moving image data generated in an imaging apparatus into a plurality of still image data pieces; an image quality calculation unit configured to calculate an image quality of each still image represented by one of the plurality of still image data pieces; and a selection unit configured to select a still image data piece for image processing to be used for image processing from among the plurality of still image data pieces based on the image quality. The selection unit is configured to select at least one or more still image data pieces satisfying a reference quality as the still image data piece(s) for image processing from among the plurality of still image data pieces arranged in an order of captured time and included in the still image data pieces from the still image data piece selected last time to a first still image data piece if it is determined that a rotation angle of the imaging apparatus when the first still image data piece included in the plurality of still image data pieces is captured exceeds a designated angle.

An imaging apparatus according to a second example aspect includes: an imaging unit configured to generate moving image data; a sensor configured to measure rotation information; and a transmission unit configured to transmit the moving image data associated with the rotation information to an image processing apparatus, the image processing apparatus being configured to select a still image data piece for image processing to be used for image processing according to a predetermined condition from among a plurality of still images converted from the moving image data.

An image processing system according to a third example aspect includes: imaging means for generating moving image data; conversion means for converting the moving image data into a plurality of still image data pieces; image quality calculation means for calculating an image quality of each still image represented by one of the plurality of still image data pieces; and selection means for selecting a still image data piece for image processing to be used for image processing from among the plurality of still image data pieces based on the image quality. The selection means selects at least one or more still image data pieces satisfying a reference quality as the still image data piece(s) for image processing from among the plurality of still image data pieces arranged in an order of captured time and included in the still image data pieces from the still image data piece selected last time to a first still image data piece if it is determined that a rotation angle of the imaging means when the first still image data piece included in the plurality of still image data pieces is captured exceeds a designated angle.

An image processing method according to a fourth example aspect of the present disclosure includes: converting moving image data generated in an imaging apparatus into a plurality of still image data pieces; calculating an image quality of each still image represented by one of the plurality of still image data pieces; and selecting a still image data piece for image processing to be used for image processing from among the plurality of still image data pieces based on the image quality. In the selecting, at least one or more still image data pieces satisfying a reference quality is selected as the still image data piece(s) for image processing from among the plurality of still image data pieces arranged in an order of captured time and included in the still image data pieces from the still image data piece selected last time to a first still image data piece if it is determined that a rotation angle of the imaging apparatus when the first still image data piece included in the plurality of still image data pieces is captured exceeds a designated angle.

A program according to a fifth example aspect of the present disclosure causes a computer to execute: converting moving image data generated in an imaging apparatus into a plurality of still image data pieces; calculating an image quality of each still image represented by one of the plurality of still image data pieces; and selecting a still image data piece for image processing to be used for image processing from among the plurality of still image data pieces based on the image quality. In the selecting, at least one or more still image data pieces satisfying a reference quality is selected as the still image data piece for image processing from among the plurality of still image data pieces arranged in an order of captured time and included in the still image data pieces from the still image data piece selected last time to a first still image data piece if it is determined that a rotation angle of the imaging apparatus when the first still image data piece included in the plurality of still image data pieces is captured exceeds a designated angle.

### Advantageous Effects of Invention

According to the present disclosure, it is possible to provide an image processing apparatus, an imaging apparatus, an image processing system, an image processing method, and a program for reducing a processing load involved in SfM.

### BRIEF DESCRIPTION OF DRAWINGS

FIG. 1 is a configuration diagram of an image processing apparatus according to a first example embodiment;

FIG. 2 is a diagram showing a configuration of an imaging apparatus according to a second example embodiment;

FIG. 3 is a configuration diagram of an image processing apparatus according to the second example embodiment;

FIG. 4 shows a flow of moving image data transmission processing in the imaging apparatus according to the second example embodiment;

FIG. 5 shows a flow of image selection processing in the image processing apparatus according to the second example embodiment;

FIG. 6 shows a flow of the image selection processing in the image processing apparatus according to the second example embodiment;

FIG. 7 shows a flow of image selection processing in the image processing apparatus according to the second example embodiment;

FIG. 8 shows a flow of moving image data transmission processing in an imaging apparatus according to a third example embodiment;

FIG. 9 shows a flow of image selection processing in the image processing apparatus according to the third example embodiment; and

FIG. 10 is a block diagram of an image processing apparatus and an imaging apparatus according to each of example embodiments.

### EXAMPLE EMBODIMENT

### First Example Embodiment

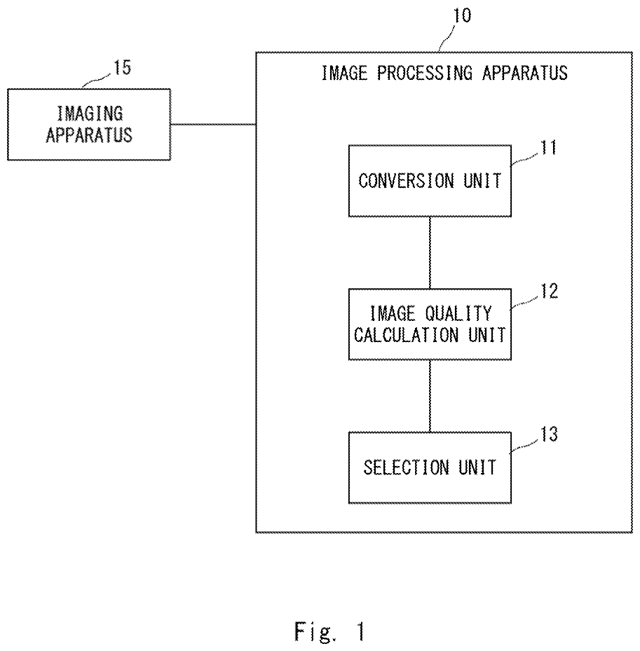

Example embodiments of the present disclosure will now be described with reference to the drawings. An example of a configuration of an image processing apparatus 10 according to a first example embodiment will be described with reference to FIG. 1. The image processing apparatus 10 may be a computer apparatus operated by a processor executing a program stored in a memory. The image processing apparatus 10 may be, for example, a server apparatus.

The image processing apparatus 10 includes a conversion unit 11, an image quality calculation unit 12, and a selection unit 13. The components of the image processing apparatus 10, such as the conversion unit 11, the image quality calculation unit 12, and the selection unit 13, may be software or modules whose processing is executed by the processor executing a program stored in a memory. Alternatively, the components of the image processing apparatus 10 may be hardware, such as circuits or chips.

The conversion unit 11 converts the moving image data generated in the imaging apparatus 15 into a plurality of still image data pieces (in other words, for example, a data set representing a plurality of still images, such as a plurality of frame images constituting the moving image data, or a data record). In the following description, a frame image is also referred to simply as a frame. The imaging apparatus 15 may be an imaging apparatus such as a camera or a computer device including a camera. The imaging apparatus 15 may be included in the image processing apparatus 10. FIG. 1 shows an example in which the imaging apparatus 15 is different from the image processing apparatus 10.

The computer apparatus including the camera may be, for example, a smartphone terminal, a tablet terminal, or the like. For example, the image processing apparatus 10 may generate an environment map of the surroundings of the smartphone terminal by using the moving image data captured by a user of the smartphone terminal while moving and may estimate the position of the smartphone terminal.

The imaging apparatus 15 may be an AGV (Automated Guided Vehicle). The image processing apparatus 10 may, for example, generate a map including a trajectory of a movement of the AGV and feature points of a structure in a factory by using the moving image data acquired from the AGV in a narrow area such as a factory.

The conversion unit 11 of the image processing apparatus 10 may acquire the moving image data from the imaging apparatus 15 via a network (communication network). The network may be, for example, a mobile network or a fixed communication network. Further, the conversion unit 11 may acquire the moving image data in a wireless or wired manner. Alternatively, the image processing apparatus 10 may acquire the moving image data via a removable recording medium. Alternatively, if the imaging apparatus 15 is a camera or the like included in the image processing apparatus 10, the conversion unit 11 may acquire the moving image data from the camera included in the image processing apparatus 10.

The moving image data may be indicated using a frame rate, for example, N (N is an integer of 1 or more) fps (frames per second). The conversion unit 11 may extract a frame included in the moving image data as a still image data piece. The frame may be referred to as a still image piece or simply an image. Converting the moving image data into a plurality of still image data pieces may be rephrased as extracting the plurality of still image data pieces from the moving image data.

The image quality calculation unit 12 calculates an image quality of each image represented by a still image piece among the plurality of still image data pieces acquired by the conversion unit 11. Calculating the image quality of each image represented by the still image data piece may be, for example, evaluating the quality of the image corresponding to the still image data piece. The image quality calculation unit 12 may calculate the image quality by, for example, performing blur detection. Calculating the image quality may be rephrased as estimating the image quality. In the following description, “the image quality of the image represented by the still image data piece” is also referred to as “the image quality of the still image data piece” for convenience of description.

The selection unit 13 selects a still image data piece for image processing to be used for image processing among the plurality of still image data pieces based on the image quality. The image processing may be, for example, image analysis processing using the still image data piece. The image processing may be, for example, SfM processing for estimating the position of the imaging apparatus 15 and generating an environmental map of the surroundings of the imaging apparatus 15. For example, the selection unit 13 selects a frame having a frame rate of N fps and less than N×M frames (N×M is an integer of 1 or more) from among N×M frames (M is an integer greater than 0) included in the moving image data of M seconds.

For example, the selection unit 13 selects the still image data piece for image processing if it is determined that a rotation angle of the imaging apparatus 15 when a first still image data piece included in the plurality of still image data pieces is captured exceeds a designated angle. The first still image data piece is, for example, a still image data piece captured at or after the time when the still image data piece for image processing selected last time is captured. The selection unit 13 selects at least one or more pieces of still image data from the still image data piece(s) selected last time to the first still image data piece among the plurality of still image data pieces from among the still image data pieces arranged in order of captured time. In this case, the selection unit 13 selects the still image data piece satisfying a reference quality as the still image data piece for image processing.

The rotation angle and the designated angle may be a rotation amount of the imaging apparatus 15 about an axis defined in a three-dimensional space. The designated angle is used as a threshold value. For example, the selection unit 13 may calculate or estimate the rotation angle of the imaging apparatus 15 when the first still image data piece is captured based on an inclination or a position of the imaging apparatus 15 when the still image data piece selected last time for image processing is captured.

The still image data piece satisfying the reference quality may be rephrased, for example, as a still image data piece whose image quality is higher than the reference quality. When there are a plurality of still image data pieces satisfying the reference quality, the selection unit 13 may select all pieces of the still image data satisfying the reference quality as the still image data piece for image processing. Alternatively, the selection unit 13 may select any one or more pieces of the still image data among the plurality of still image data pieces satisfying the reference quality as the still image data piece(s) for image processing. The reference quality may be, for example, a blur level estimated in blur detection, a blur value, or the like.

As described above, the image processing apparatus 10 can select the still image data piece for image processing if the rotation angle of the imaging apparatus 15 when the first still image data piece included in the plurality of still image data pieces is captured exceeds the designated angle.

In this way, the number of the still image data pieces used in the image processing such as SfM in the image processing apparatus 10 is reduced as compared with that in the case where all frames included in the moving image data are used. Therefore, a processing load of the image processing using the still image data piece selected by the image processing apparatus 10 is reduced as compared with that in the case where all frames included in the moving image data are used.

Further, if the plurality of selected still image data pieces do not include the same feature points, the image processing such as estimation of the position of the imaging apparatus 15 may not be performed effectively. On the other hand, the image processing apparatus 10 can select still image data piece captured at a timing near the timing when the rotation angle of the imaging apparatus 15 exceeds the designated angle. In this manner, the image processing apparatus 10 can improve the possibility of selecting a still image data piece including the same feature points even during a period in which the rotation angle of the image processing apparatus 10 varies greatly.

### Second Example Embodiment

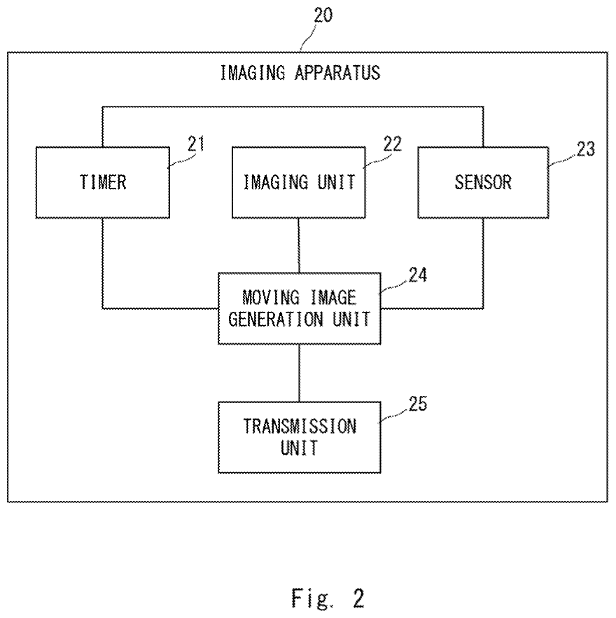

Next, a configuration example of an imaging apparatus 20 according to a second example embodiment will be described with reference to FIG. 2. The imaging apparatus 20 corresponds to the imaging apparatus 15 according to the first example embodiment. The imaging apparatus 20 may be a computer apparatus operated by a processor executing a program stored in a memory.

The imaging apparatus 20 includes a timer 21, an imaging unit 22, a sensor 23, a moving image generation unit 24, and a transmission unit 25. The imaging unit 22, the moving image generation unit 24, and the transmission unit 25 may be software or a module in which processing is executed by the processor executing a program stored in a memory. Alternatively, each of the imaging unit 22, the moving image generation unit 24, and the transmission unit 25 may be hardware such as a circuit or a chip.

The timer 21 provides the time to the components of the imaging apparatus 20. The timer 21 may be, for example, software or hardware using a counter circuit or the like.

The imaging unit 22 captures the periphery of the imaging apparatus 20 and outputs the captured data to the moving image generation unit 24.

The sensor 23 is a sensor for detecting information (e.g., information that directly or indirectly represents an inclination state, a rotation mode, and a posture before and after rotation of the imaging apparatus 20: such information is hereinafter referred to as rotation information) related to rotation (turn) of the imaging apparatus 20. The sensor 23 may include, for example, an acceleration sensor and an angular velocity sensor (gyro sensor), and may be an Inertial Measurement Unit (IMU) sensor. Accordingly, the rotation information is information used to calculate or estimate the rotation angle. More specifically, the rotation information may include at least one of an angular velocity and a value indicating the inclination of the imaging apparatus 20 with respect to an axis in the three-dimensional space. The inclination of the imaging apparatus 20 may be calculated based on the output of the acceleration sensor, the IMU sensor, or the like. The sensor 23 transmits the detected rotation information to the moving image generation unit 24.

The moving image generation unit 24 generates moving image data having a predetermined frame rate by using the data received from the imaging unit 22. The moving image generation unit 24 associates time information provided from the timer 21 with the moving image data. Specifically, the moving image generation unit 24 may associate each frame included in the moving image data with the time at which the frame is captured.

Further, the moving image generation unit 24 associates the moving image data with the rotation information received from the sensor 23. Specifically, the moving image generation unit 24 may associate each frame included in the moving image data with at least one of the angular velocity of the imaging apparatus 20 and the inclination of the imaging apparatus 20 when the frame is captured.

The transmission unit 25 transmits, to an image processing apparatus 30, the moving image data generated by the moving image generation unit 24 and associated with the time information and the rotation information. The transmission unit 25 may transmit the moving image data in a wireless or wired manner.

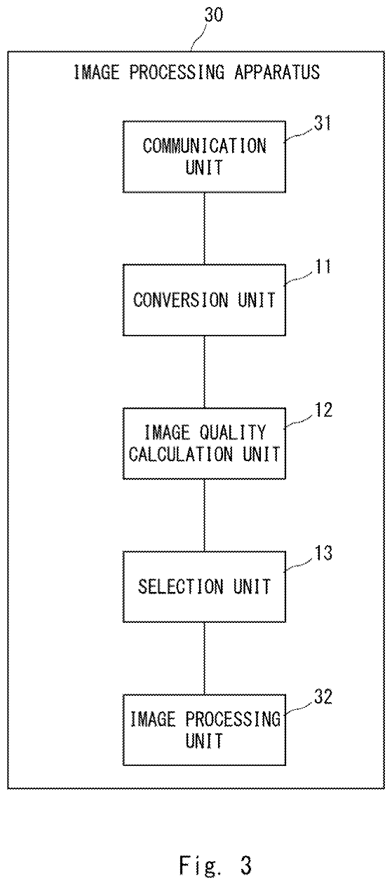

Next, a configuration example of the image processing apparatus 30 according to the second example embodiment will be described with reference to FIG. 3. The image processing apparatus 30 has a configuration further including a communication unit 31 and an image processing unit 32 in addition to the components of the image processing apparatus 10 shown in FIG. 1. In the following description of the image processing apparatus 30, the description of processing, functions, and the like that are the same as those of the image processing apparatus 10 is omitted.

The communication unit 31 receives the moving image data transmitted from the imaging apparatus 20. The time information and the rotation information are associated with the moving image data received by the communication unit 31.

The conversion unit 11 arranges a plurality of still image data pieces converted from the moving image data in chronological order (time series). In other words, the conversion unit 11 arranges the plurality of still image data pieces in order from the still image data piece having an oldest captured time to the still image data piece having a newest captured time.

Alternatively, the conversion unit 11 may output the plurality of still image data pieces converted from the moving image data to the image quality calculation unit 12, and the image quality calculation unit 12 may arrange the plurality of still image data pieces in chronological order.

The selection unit 13 first selects the still image data piece having the oldest captured time as the still image data piece for image processing. Alternatively, the selection unit 13 may first check the still image data pieces in order of the captured time, and select the first still image data piece satisfying a minimum quality as the still image data piece for image processing. The minimum quality may be, for example, a quality that the still image data piece that can be used for the SfM processing must at least satisfy. Alternatively, the selection unit 13 may first check the still image data pieces in order of the captured time, and select the first still image data piece satisfying the designated quality. The designated quality may be a quality to be satisfied for efficiently performing the SfM processing. The designated quality is higher than the minimum quality.

The selection unit 13 selects the still image data piece for image processing based on the time information or the rotation information associated with the still image data piece when selecting the next still image data piece for image processing after first selecting the still image data piece for image processing.

The selection unit 13 may select the still image data piece for image processing from among the still image data pieces captured during the period from the captured time of the still image data piece selected last time for image processing until the time at which a designated period has elapsed.

Alternatively, if the selection unit 13 determines that the rotation angle of the imaging apparatus 20 when the first still image data piece included in the plurality of still image data pieces is captured exceeds a designated angle, the selection unit 13 may select the still image data piece for image processing from among the still image data pieces within a predetermined range. The still image data pieces within the predetermined range may be from the still image data piece for image processing selected last time to the first still image data piece. When the selection unit 13 selects the still image data, it may select at least one still image data piece satisfying the designated quality as the still image data piece for image processing.

For example, the selection unit 13 may calculate the rotation angle based on the difference between the inclination of the imaging apparatus 20 associated with the still image data piece selected last time and the inclination of the imaging apparatus 20 associated with the first still image data piece. Alternatively, the selection unit 13 may calculate the rotation angle of the imaging apparatus 20 by integrating the angular velocities associated with the respective still image data pieces from the still image data piece selected last time to the first still image data piece.

The image processing unit 32 uses the plurality of still image data pieces for image processing selected by the selection unit 13 to perform image processing such as SfM.

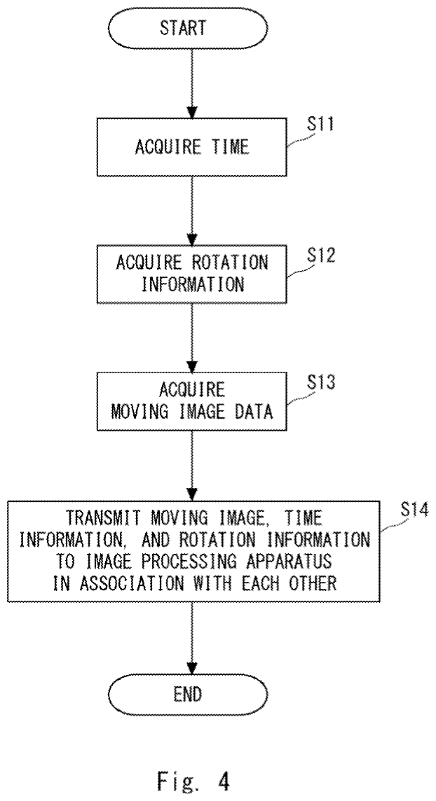

Next, a flow of the moving image data transmission processing in the imaging apparatus 20 according to second example embodiment will be described with reference to FIG. 4. First, the moving image generation unit 24 acquires the current time from the timer 21 (S11). Next, the moving image generation unit 24 acquires the rotation information from the sensor 23 (S12). Next, the moving image generation unit 24 acquires the moving image data from the imaging unit 22 (S13). The processing in Steps S11 to S13 are not limited to the order shown in FIG. 4, and may be executed in any order. Alternatively, the processing in Steps S11 to S13 may be performed in parallel.

Next, the transmission unit 25 transmits the moving image data associated with the time information and the rotation information to the image processing apparatus 30 (S14).

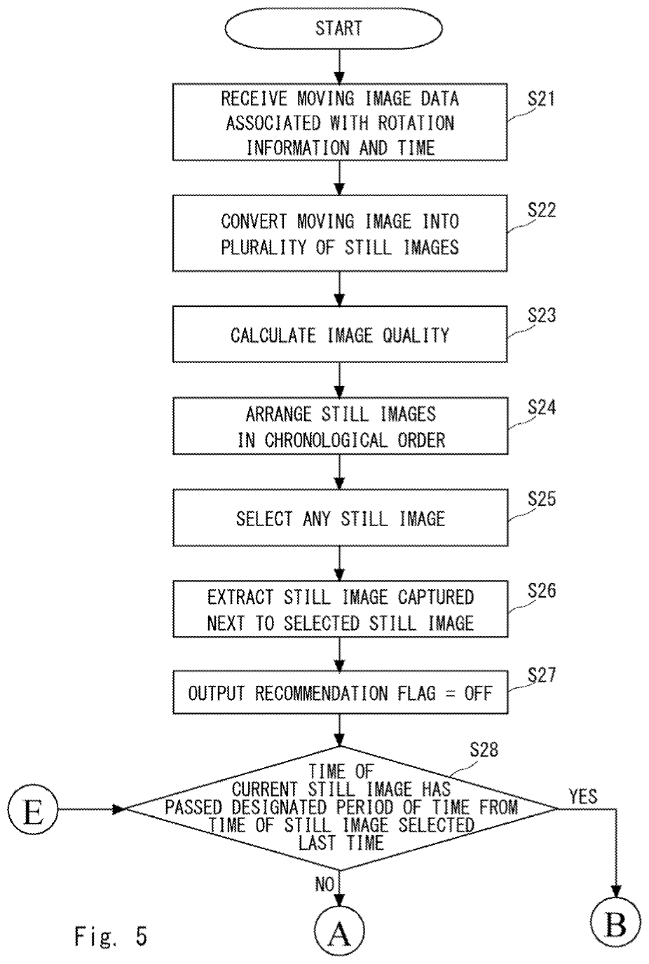

Next, a flow of the image selection processing in the image processing apparatus 30 will be described with reference to FIGS. 5 to 7. First, the communication unit 31 receives the moving image data associated with the time information and the rotation information (S21).

Next, the conversion unit 11 converts the moving image data into a plurality of still image data pieces (S22). Next, the image quality calculation unit 12 calculates the image quality of the plurality of still image data pieces (S23). For example, the image quality calculation unit 12 calculates the image quality of each still image data piece by performing blur detection.

Next, the conversion unit 11 or the image quality calculation unit 12 arranges the plurality of still image data pieces from the still image data piece having the oldest captured time to the still image data piece having the newest captured time (S24). The processing of Step S24 may be performed before Step S23.

Next, the selection unit 13 selects any still image data piece as the still image data piece for image processing (S25). For example, the selection unit 13 may select the still image data piece having the oldest captured time. Alternatively, the selection unit 13 may check the still image data pieces in order of the captured time from the oldest one and select the first still image data piece satisfying the minimum quality. Further alternatively, the selection unit 13 may check the still image data pieces in order of the captured time from the oldest one and select the first still image data piece satisfying the designated quality.

Next, the selection unit 13 extracts the still image data piece captured next to the still image data piece selected in Step S25 (S26).

Next, the selection unit 13 sets an output recommendation flag to OFF (S27). The output recommendation flag is used to determine whether to execute processing for determining whether or not the still image data piece extracted in Step S26 satisfies the minimum quality.

Next, the selection unit 13 determines whether or not the time associated with the current still image data piece extracted in Step S26 has passed a designated period of time from the time associated with the still image data piece selected last time as the still image data piece for image processing (S28). The designated period of time is a predetermined value and may be stored in a memory or the like in the image processing apparatus 30. The designated period of time may be, for example, a period determined by an administrator or the like of the image processing apparatus 30.

If it is determined that the designated period of time has not elapsed, the selection unit 13 determines whether or not the rotation angle of the imaging apparatus 20 when the current still image data piece extracted in Step S26 is captured exceeds the designated angle (S29).

If it is determined that the rotation angle of the imaging apparatus 20 when the current still image data piece extracted in Step S26 is captured exceeds the designated angle, the selection unit 13 executes the processing of Step S30. In Step S30, the selection unit 13 determines whether or not there is a still image data piece satisfying the designated quality among the still image data pieces from the still image data piece selected last time to the current still image data piece extracted in Step S26 (Step S30). In Step S28, the selection unit 13 also executes the processing of Step S30 when it is determined that the designated period of time has elapsed.

If it is determined in Step S30 that there is a still image data piece satisfying the designated quality among the still image data pieces from the still image data piece selected last time to the current still image data piece extracted in Step S26, the selection unit 13 executes the processing in Step S34. In Step S34, the selection unit 13 selects the most recent still image data piece among the still image data pieces satisfying the designated quality (S34). The most recent still image data piece is a still image data piece captured most recently.

If it is determined in Step 30 that there is no still image data piece satisfying the designated quality among the still image data pieces from the still image data piece selected last time to the current still image data piece extracted in Step S26, the selection unit 13 executes the processing in Step S31. In Step S31, the selection unit 13 determines whether or not the current still image data piece selected in Step S26 satisfies the minimum quality (Step S31). If it is determined that the current still image data piece selected in Step S26 satisfies the minimum quality, the selection unit 13 selects the current still image data piece as the still image data piece for image processing (S33). If it is determined that the current still image data piece selected in Step S26 does not satisfy the minimum quality, the selection unit 13 sets the output recommendation flag to ON (S32).

The selection unit 13 executes the processing of Step S35 after Steps S32 to 34. Further, if it is determined in Step S29 that the difference in the rotation angles does not exceed the designated angle, the selection unit 13 executes the processing of Step S35.

In Step S35, the selection unit 13 determines whether or not all the still image data pieces have been extracted (S35). All still image data pieces are all still image data pieces converted from the moving image data in Step S22.

When the selection unit 13 extracts all the still image data pieces, it means that the selection unit 13 extracts the last still image data piece among the still image data pieces arranged in chronological order in Step S26.

If it is determined in Step S35 that the selection unit 13 has extracted all the still image data pieces, the image processing unit 32 performs image processing using all the data pieces selected as the still image data piece for image processing (Step S37). If it is determined in Step S35 that all the still image data pieces are not extracted, the selection unit 13 extracts the still image data piece that is the next oldest after the still image data piece extracted in Step S26 (Step S36). The still image data that is the next oldest to the still image data piece extracted in Step S26 is the still image data that is next to the still image data piece extracted in Step S26 among the still image data pieces arranged in chronological order. That is, the selection unit 13 extracts the still image data piece captured next to the still image data piece extracted in Step S26.

Next, the selection unit 13 determines whether or not the current output recommendation flag is set to ON (S38). If it is determined that the current output recommendation flag is set to ON, the selection unit 13 repeats the processing from Step S31 onward. If it is determined that the current output recommendation flag is set to OFF, the selection unit 13 repeats the processing from Step S28 onward.

As described above, when the designated period of time has elapsed, the image processing apparatus 30 can select the still image data piece satisfying the designated quality or the minimum quality from among the still image data pieces between the still image data piece selected last time and the currently extracted still image data piece. The image processing apparatus 30 selects a still image data piece satisfying the designated quality or the minimum quality, so that a still image data piece whose feature points are clearly displayed can be used for the SfM processing. When a still image data piece that does not satisfy the designated quality or the minimum quality is selected, a fine difference between still image data pieces is not recognized, and the SfM processing is performed using only distinctive features. In this case, the accuracy of the SfM processing is reduced. On the other hand, the image processing apparatus 30 can recognize a fine difference between the still image data pieces by selecting a still image data piece satisfying the designated quality or the minimum quality, thereby improving the accuracy of the SfM processing.

Further, the image processing apparatus 30 can improve the possibility that a plurality of still image data pieces include the same feature points by periodically selecting the still image data pieces. If the designated period of time is too long, the possibility that the same feature points are included in the still image data piece to be periodically selected is reduced. For this reason, the designated period of time should be long enough to allow selection of the still image data pieces including the same feature points. As described above, by periodically selecting the still image data pieces, the image processing apparatus 30 can select the still image data pieces including the same feature points even when the imaging apparatus 20 moves straight without shaking the camera and is not rotated so as to exceed the designated angle.

Further, the image processing apparatus 30 can select the still image data piece even before the designated period of time has elapsed, if the imaging apparatus 20 is rotated so as to exceed the designated angle. For example, a case where the imaging apparatus 20 quickly changes the direction within the designated period of time will be described. In this case, when the image processing apparatus 30 selects the still image data piece at the timing when the designated period of time elapses, the same feature points are not included in the still image data piece before the direction change of the imaging apparatus 20 and the still image data piece after the direction change of the imaging apparatus 20. On the other hand, even before the designated period of time has elapsed, the image processing apparatus 30 can select the still image data piece during the direction change by selecting the still image data piece when the rotation angle of the imaging apparatus 20 exceeds the designated angle. As a result, it is possible to improve the possibility that the same feature points are included in the plurality of selected still image data pieces.

### Third Example Embodiment

Next, image selection processing according to a third example embodiment will be described. In the third example embodiment, instead of the time information, information about a movement of the imaging apparatus 20 (hereinafter referred to as movement information) that directly or indirectly represents a movement state of the imaging apparatus 20, such as a moving speed and a movement mode, is used. That is, in the third example embodiment, the selection unit 13 selects the still image data piece based on the movement information or the rotation information associated with the still image data piece. The selection unit 13 may measure a moving distance of the imaging apparatus 20 based on the moving information. When the moving distance of the imaging apparatus 20 exceeds a predetermined designated distance, the selection unit 13 selects the still image data piece from among the still image data pieces captured during the period from the still image data piece selected last time until the imaging apparatus 20 moves to a position separated by the designated distance.

Alternatively, the selection unit 13 may measure the speed of the imaging apparatus 20 based on the movement information. When the speed of the imaging apparatus 20 exceeds the designated speed, the selection unit 13 may select the still image data piece from among the still image data pieces captured during the period from the still image data piece selected last time until the imaging apparatus 20 exceeds the designated speed.

The movement information may be, for example, an acceleration detected by the sensor 23 of the imaging apparatus 20. For example, the moving image generation unit 24 of the imaging apparatus 20 may associate each frame included in the moving image data with the acceleration of the imaging apparatus 20 when the frame is captured. The imaging apparatus 20 transmits the moving image data associated with the acceleration to the image processing apparatus 30.

The selection unit 13 may measure the moving distance or the speed of the imaging apparatus 20 by integrating the acceleration associated with the still image data pieces arranged in chronological order.

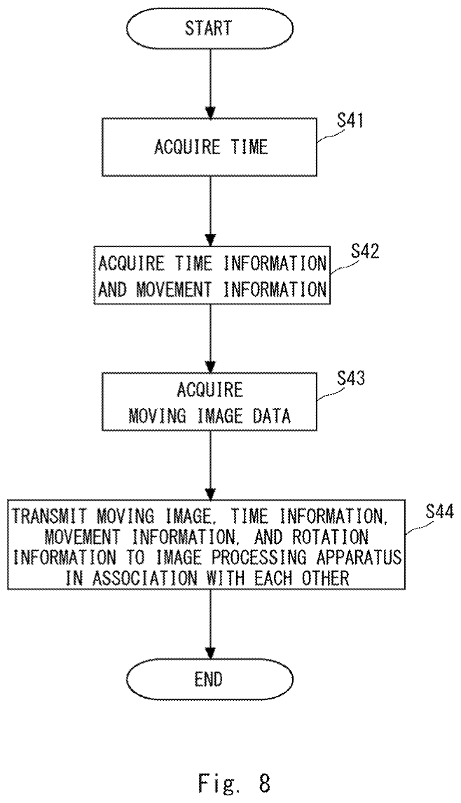

Referring now to FIG. 8, a flow of the moving image data transmission processing in the imaging apparatus 20 according to the third example embodiment will be described. Steps S41 and S43 in FIG. 8 are the same as Steps S11 and S13 in FIG. 4, respectively, and therefore a detailed description thereof will be omitted. Following Step S41, the moving image generation unit 24 acquires the time information and the movement information from the sensor 23 (Step S42). Following Step S43, the transmission unit 25 transmits the moving image data associated with the time information, the movement information, and the rotation information to the image processing apparatus 30 (Step S44).

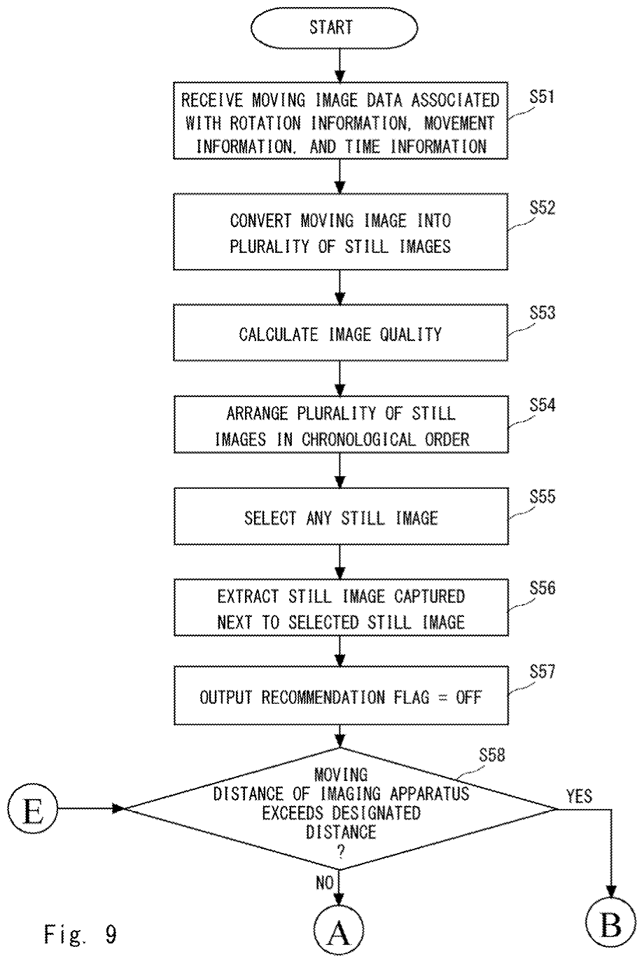

Next, a flow of the image selection processing according to the third example embodiment will be described with reference to FIG. 9. First, the communication unit 31 receives the moving image data associated with the time information, the movement information, and the rotation information (Step S51). Steps S52 to S57 are the same as Steps S22 to S27 in FIG. 5, respectively, and therefore a detailed description thereof will be omitted.

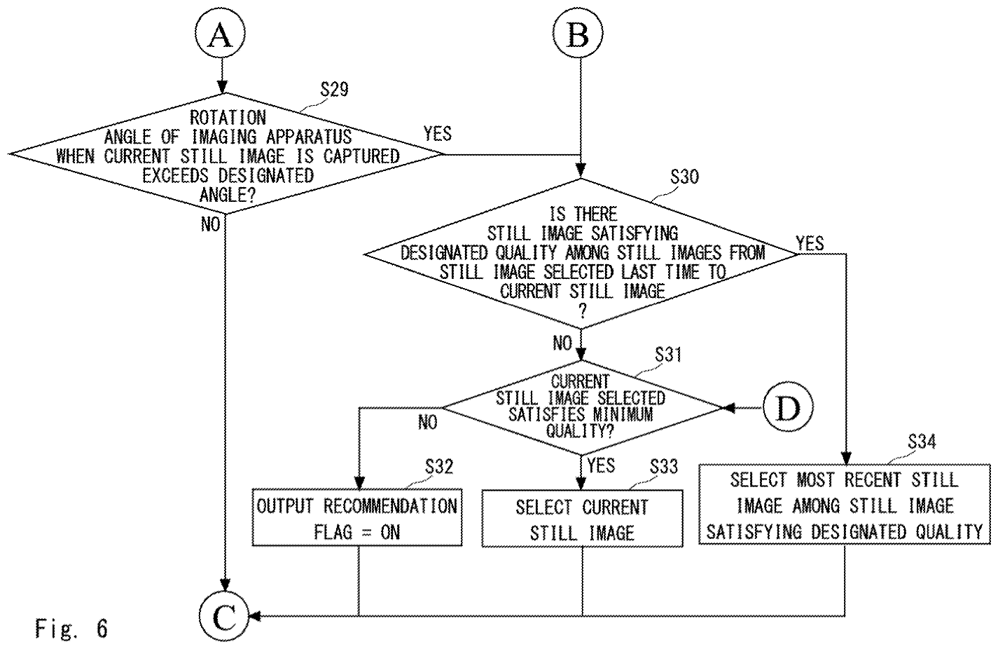

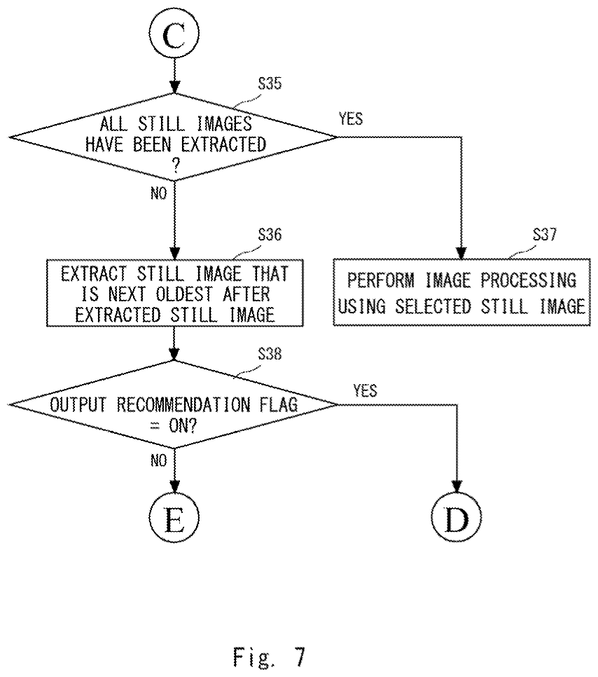

Next, the selection unit 13 determines whether or not the distance that the imaging apparatus 20 has moved from the time when the still image data piece selected last time is captured until the time when the current still image data piece extracted in Step S56 is captured exceeds the designated distance (S58). Since the processing from Step S58 onward is the same as that in FIGS. 6 and 7, a detailed description thereof will be omitted. In Step S58, the selection unit 13 may determine whether the moving speed of the imaging apparatus 20 exceeds the designated speed during the period from the time when the still image data piece selected last time is captured until the time when the current still image data piece extracted in Step S56 is captured.

As described above, in the third example embodiment, the image processing apparatus 30 can select the still image data piece as the still image data piece for image processing even before the designated period of time elapses, if the imaging apparatus 20 has moved more than the designated distance. Alternatively, the image processing apparatus 30 can select the still image data piece as the still image data piece for image processing when the imaging apparatus 20 moves at a speed exceeding the designated speed.

For example, if the imaging apparatus 20 moves more than the designated distance within the designated period of time, if two pieces of still image data are selected at different timings with the designated period of time between the timings, the distances in a physical space between the individual images represented by the two pieces of still image data become too distant (the physical space is a physical space in which the imaging apparatus 20 is present). In this case, the same feature points are not included in the plurality of selected still image data pieces. On the other hand, even before the designated period of time elapses, the image processing apparatus 30 can select the still image data piece captured at a distance within the designated distance by selecting the still image data pieces when the imaging apparatus 20 reaches the designated distance. As a result, it is possible to improve the possibility that the same feature points are included in the plurality of selected still image data pieces.

Even when the image processing apparatus 30 moves at a speed exceeding the designated speed, the same effect as that when the still image data piece is selected based on the designated distance can be acquired.

The still image data selection processing according to the third example embodiment may be combined with the still image data selection processing according to the second example embodiment. For example, if the selection unit 13 determines in Step S28 of FIG. 5 that the designated period of time has not elapsed, the processing from Step S58 of FIG. 9 onward may be performed.

Alternatively, the processing of Step S58 in FIG. 9 may be executed after Step S27 in FIG. 5. In this case, if the selection unit 13 determines in Step S58 that the moving distance of the imaging apparatus 20 does not exceed the designated distance, the processing from Step S28 onward in FIG. 5 may be performed.

Alternatively, in Step S29 of FIG. 6, if the selection unit 13 determines that the difference in the rotation angles of the imaging apparatus 20 does not exceed the designated angle, the processing of Step S58 of FIG. 9 may be executed. In this case, if the selection unit 13 determines in Step S58 that the moving distance of the imaging apparatus 20 does not exceed the designated distance, the processing from Step S35 onward in FIG. 7 may be performed. Further, if the selection unit 13 determines in Step S58 that the moving distance exceeds the designated distance, the processing from Step S30 onward in FIG. 6 may be performed.

### Fourth Example Embodiment

Next, a method of determining a designated period of time, a designated angle, a designated distance, or a designated speed according to the fourth example embodiment will be described. In the first to third example embodiments, a predetermined value or a value input by an administrator or the like is used as the designated period of time, the designated angle, the designated distance, or the designated speed.

In the fourth example embodiment, it will be described that the designated period of time, the designated angle, the designated distance, or the designated speed is selected according to the quality of the still image data piece.

Specifically, when the quality of the selected still image data piece is higher than the designated quality, the values of the designated period of time, the designated angle, the designated distance, or the designated speed may be larger than the current value. Further, if the quality of the selected still image data piece is lower than the designated quality, the value of the designated period of time, the designated angle, the designated distance, or the designated speed may be smaller than the current value.

For example, a case where the quality of the still image data piece can be expressed numerically and the higher the numerical value, the higher the quality will be described. In this case, the value of the current designated period of time may be multiplied by the quality/designated quality of the selected still image data piece to calculate the value of the new designated period of time. The quality/designated quality of the selected still image data piece indicates that the quality of the selected still image data piece is divided by the designated quality. Similarly, for the designated angle, the designated distance, or the designated speed, a new value may be calculated by multiplying the current value by the quality/designated quality of the selected still image data piece.

As described above, in the fourth example embodiment, the values of the designated period of time, the designated angle, the designated distance, or the designated speed can be optimized according to the quality of the selected still image data piece. Thus, the period for selecting the still image data piece can be extended while the still image data piece of high quality is being selected. In this case, since the still image data piece of high quality is continuously selected, highly accurate self-localization can be performed with SfM. While the still image data piece of low quality is being selected, the period for selecting the still image data piece can be reduced. In this case, the accuracy of the self-localization or the like can be maintained by increasing the number of still image data pieces used for the SfM.

Further, weighting may be taken into account when a new value is calculated for the designated period of time, the designated angle, the designated distance, or the designated speed. For example, a new value of the designated period of time, the designated angle, the designated distance, or the designated speed may be multiplied by values different from each other. For example, the larger a value by which the calculated new value is multiplied, the longer the period for selecting the still image data piece can be extended.

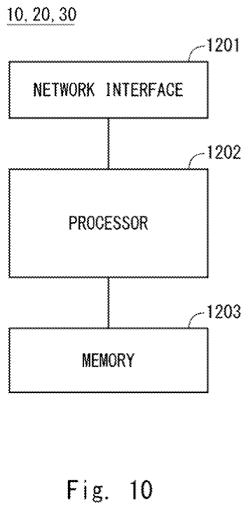

FIG. 10 is a block diagram showing a configuration example of the image processing apparatus 10, the imaging apparatus 20, and the image processing apparatus 30 (hereinafter, each of them will be referred to as the image processing apparatus 10 or the like). Referring to FIG. 10, the image processing apparatus 10 or the like includes a network interface 1201, a processor 1202, and a memory 1203. The network interface 1201 is used to communicate with a network node (e.g., eNB, MME, P-GW). The network interface 1201 may include, for example, a network interface card (NIC) compliant with the IEEE 802.3 series. Here, eNB represents an evolved Node B, MME represents a Mobility Management Entity, and P-GW represents a Packet Data Network Gateway. IEEE stands for Institute of Electrical and Electronics Engineers.

The processor 1202 reads the software (computer programs) from the memory 1203 and executes it to perform processing of the image processing apparatus 10 or the like explained by using the flowchart in each of the above example embodiments. The processor 1202 may be, for example, a microprocessor, an MPU (Micro Processor Unit), or a CPU (Central Processing Unit). The processor 1202 may include a plurality of processors.

The memory 1203 is composed of, for example, a combination of a volatile memory and a non-volatile memory. The memory 1203 may include a storage disposed separately from the processor 1202. In this case, the processor 1202 may access the memory 1203 through an I/O (Input/Output) interface (not shown).

In the example of FIG. 10, the memory 1203 is used to store software modules. The processor 1202 reads these software modules from the memory 1203 and executes them to perform the processing of the image processing apparatus 10 or the like described in the above example embodiments.

As described with reference to FIG. 10, each of the processors of the image processing apparatus 10 or the like in the above-described embodiment executes one or more programs including instructions for causing a computer to perform the algorithm described with reference to the drawings.

The above program can be stored and provided to a computer using any type of non-transitory computer readable media.

Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Note that the present disclosure is not limited to the above-described example embodiments, and may be changed as appropriate without departing from the spirit.

The whole or part of the example embodiment disclosed above can be described as, but not limited to, the following supplementary notes.

### (Supplementary Note 1)

An image processing apparatus comprising:

a conversion unit configured to convert moving image data generated in an imaging apparatus into a plurality of still image data pieces;
an image quality calculation unit configured to calculate an image quality of each still image represented by one of the plurality of still image data pieces; and
a selection unit configured to select a still image data piece for image processing to be used for image processing from among the plurality of still image data pieces based on the image quality, wherein
the selection unit is configured to select at least one or more still image data pieces satisfying a reference quality as the still image data piece(s) for image processing from among the plurality of still image data pieces arranged in an order of captured time and included in the still image data pieces from the still image data piece selected last time to a first still image data piece if it is determined that a rotation angle of the imaging apparatus when the first still image data piece included in the plurality of still image data pieces is captured exceeds a designated angle.

### (Supplementary Note 2)

The image processing apparatus according to Supplementary note 1, wherein
the selection unit is configured to acquire rotation information about a rotation of the imaging apparatus measured by a sensor included in the imaging apparatus, and identify the rotation angle based on the rotation information.

### (Supplementary Note 3)

The image processing apparatus according to Supplementary note 2, wherein
the rotation information uses at least one of an angular velocity of the imaging apparatus and an angle indicating an inclination of the imaging apparatus with respect to a predetermined axis.

### (Supplementary Note 4)

The image processing apparatus according to any one of Supplementary notes 1 to 3, wherein
the designated angle is calculated based on the image quality of the still image represented by the still image data piece for image processing selected last time.

### (Supplementary Note 5)

The image processing apparatus according to Supplementary note 4, wherein
when the image quality of the still image represented by the still image data piece for image processing selected last time is better than a predetermined image quality, an angle larger than that when the image quality of the still image represented by the still image data piece for image processing selected last time is worse than the predetermined image quality is set as the designated angle.

### (Supplementary Note 6)

The image processing apparatus according to any one of Supplementary notes 1 to 5, wherein
when a first period of time has elapsed from a time when the still image data piece selected last time for image processing is captured, the selection unit is configured to select at least one or more still image data pieces satisfying the reference quality as the still image data piece(s) for image processing from among the still image data pieces captured during the first period of time.

### (Supplementary Note 7)

The image processing apparatus according to Supplementary note 6, wherein
the first period of time is calculated based on the image quality of the still image represented by the still image data piece for image processing selected last time.

### (Supplementary Note 8)

The image processing apparatus according to Supplementary note 7, wherein
when the image quality of the still image represented by the still image data piece for image processing selected last time is better than a predetermined image quality, a period of time longer than that when the image quality of the still image represented by the still image data piece for image processing selected last time is worse than the predetermined image quality is set as the first period.

### (Supplementary Note 9)

The image processing apparatus according to any one of Supplementary note 1 to 8, wherein
the selection unit is configured to select at least one or more still image data pieces satisfying the reference quality as the still image data piece(s) for image processing from among the plurality of still image data pieces arranged in an order of captured time and included in the still image data pieces from the still image data piece selected last time to a second still image data piece if it is determined that a moving distance of the imaging apparatus when the second still image data piece included in the plurality of still image data pieces is captured exceeds a designated distance.

### (Supplementary Note 10)

The image processing apparatus according to Supplementary note 9, wherein
the selection unit is configured to acquire an acceleration measured by the sensor included in the imaging apparatus, and identifies the moving distance based on the acceleration.

### (Supplementary Note 11)

The image processing apparatus according to Supplementary note 10, wherein
the designated distance is calculated based on the image quality of the still image represented by the still image data piece for image processing selected last time.

### (Supplementary Note 12)

The image processing apparatus according to Supplementary note 11, wherein
when the image quality of the still image data piece for image processing selected last time is better than a predetermined image quality, a distance longer than that when the image quality of the still image represented by the still image data piece for image processing selected last time is worse than the predetermined image quality is set as the designated distance.

### (Supplementary Note 13)

The image processing apparatus according to any one of Supplementary notes 1 to 12, wherein
the reference quality includes a designated quality and a minimum quality inferior to the designated quality, and
the selection unit is configured to select at least one still image data piece satisfying the designated quality, and when there is no still image data piece satisfying the designated quality, the selection means selects at least one still image data piece satisfying the minimum quality.

### (Supplementary Note 14)

An imaging apparatus comprising:
an imaging unit configured to generate moving image data;
a sensor configured to measure rotation information related to a rotation of the imaging unit; and
a transmission unit configured to transmit the moving image data associated with the rotation information to an image processing apparatus, the image processing apparatus being configured to select a still image data piece for image processing to be used for image processing according to a predetermined condition from among a plurality of still images converted from the moving image data.

### (Supplementary Note 15)

The image processing apparatus according to Supplementary note 14, wherein
the transmission unit configured to transmit the moving image data associated with at least one of timer information indicating a time when the moving image data is captured and a moving distance of the imaging apparatus.

### (Supplementary Note 16)

An image processing system comprising:
imaging means for generating moving image data;
   conversion means for converting the moving image data into a plurality of still image data pieces;
image quality calculation means for calculating an image quality of each still image represented by one of the plurality of still image data pieces; and
selection means for selecting a still image data piece for image processing to be used for image processing from among the plurality of still image data pieces based on the image quality, wherein
the selection means selects at least one or more still image data pieces satisfying a reference quality as the still image data piece(s) for image processing from among the plurality of still image data pieces arranged in an order of captured time and included in the still image data pieces from the still image data piece selected last time to a first still image data piece if it is determined that a rotation angle of the imaging means when the first still image data piece included in the plurality of still image data pieces is captured exceeds a designated angle.

### (Supplementary Note 17)

The image processing system according to Supplementary note 16, wherein
the selection means identifies the rotation angle based on the rotation information about a rotation of the imaging means measured by the sensor.

### (Supplementary Note 18)

An image processing method comprising:

converting moving image data generated in an imaging apparatus into a plurality of still image data pieces;
calculating an image quality of each still image represented by one of the plurality of still image data pieces; and
selecting a still image data piece for image processing to be used for image processing from among the plurality of still image data pieces based on the image quality, wherein
in the selecting, at least one or more still image data pieces satisfying a reference quality is selected as the still image data piece(s) for image processing from among the plurality of still image data pieces arranged in an order of captured time and included in the still image data pieces from the still image data piece selected last time to a first still image data piece if it is determined that a rotation angle of the imaging apparatus when the first still image data piece included in the plurality of still image data pieces is captured exceeds a designated angle.

### (Supplementary Note 19)

A program for causing a computer to execute:
converting moving image data generated in an imaging apparatus into a plurality of still image data pieces;
calculating an image quality of each still image represented by one of the plurality of still image data pieces; and
selecting a still image data piece for image processing to be used for image processing from among the plurality of still image data pieces based on the image quality, wherein
in the selecting, at least one or more still image data pieces satisfying a reference quality is selected as the still image data piece(s) for image processing from among the plurality of still image data pieces arranged in an order of captured time and included in the still image data pieces from the still image data piece selected last time to a first still image data piece if it is determined that a rotation angle of the imaging apparatus when the first still image data piece included in the plurality of still image data pieces is captured exceeds a designated angle.

Although the present disclosure has been described with reference to the example embodiments, the present disclosure is not limited by the above. The configuration and details of the present disclosure may be modified in various ways that will be understood by those skilled in the art within the scope of the disclosure.

This application claims priority on the basis of Japanese Patent Application No. 2020-030451, filed Feb. 26, 2020, the entire disclosure of which is incorporated herein by reference.

### REFERENCE SIGNS LIST

10 IMAGE PROCESSING APPARATUS
11 CONVERSION UNIT
12 IMAGE QUALITY CALCULATION UNIT
13 SELECTION UNIT
15 IMAGING APPARATUS
20 IMAGING APPARATUS
21 TIMER
22 IMAGING UNIT
23 SENSOR
24 MOVING IMAGE GENERATION UNIT
25 TRANSMISSION UNIT
30 IMAGE PROCESSING APPARATUS
31 COMMUNICATION UNIT
32 IMAGE PROCESSING UNIT

What is claimed is:

1. An image processing apparatus comprising:
at least one memory storing instructions, and
at least one processor configured to execute the instructions to;
convert moving image data generated in an imaging apparatus into a plurality of still image data pieces;
calculate an image quality of each still image represented by one of the plurality of still image data pieces;
select a still image data piece for image processing to be used for image processing from among the plurality of still image data pieces based on the image quality; and
select at least one or more still image data pieces satisfying a reference quality as the still image data piece(s) for image processing from among the plurality of still image data pieces arranged in an order of captured time and included in the still image data pieces from the still image data piece selected last time to a first still image data piece if it is determined that a rotation angle of the imaging apparatus when the first still image data piece included in the plurality of still image data pieces is captured exceeds a designated angle.

2. The image processing apparatus according to claim 1, wherein
the at least one processor is further configured to execute the instructions to acquire rotation information about a rotation of the imaging apparatus measured by a sensor included in the imaging apparatus, and estimate the rotation angle based on the rotation information.

3. The image processing apparatus according to claim 2, wherein
the rotation information uses at least one of an angular velocity of the imaging apparatus and an angle indicating an inclination of the imaging apparatus with respect to a predetermined axis.

4. The image processing apparatus according to claim 1, wherein
the designated angle is calculated based on the image quality of the still image represented by the still image data piece for image processing selected last time.

5. The image processing apparatus according to claim 4, wherein
when the image quality of the still image represented by the still image data piece for image processing selected last time is better than a predetermined image quality, an angle larger than that when the image quality of the still image represented by the still image data piece for image processing selected last time is worse than the predetermined image quality is set as the designated angle.

6. The image processing apparatus according to claim 1, wherein
when a first period of time has elapsed from a time when the still image data piece selected last time for image processing is captured, the at least one processor is further configured to execute the instructions to select at least one or more still image data pieces satisfying the reference quality as the still image data piece(s) for image processing from among the still image data pieces captured during the first period of time.

7. The image processing apparatus according to claim 6, wherein
the first period of time is calculated based on the image quality of the still image represented by the still image data piece for image processing selected last time.

8. The image processing apparatus according to claim 7, wherein
when the image quality of the still image represented by the still image data piece for image processing selected last time is better than a predetermined image quality, a period of time longer than that when the image quality of the still image represented by the still image data piece for image processing selected last time is worse than the predetermined image quality is set as the first period.

9. The image processing apparatus according to claim 1, wherein
the at least one processor is further configured to execute the instructions to select at least one or more still image data pieces satisfying the reference quality as the still image data piece for image processing from among the plurality of still image data pieces arranged in an order of captured time and included in the still image data pieces from the still image data piece selected last time to a second still image data piece if it is determined that a moving distance of the imaging apparatus when the second still image data piece included in the plurality of still image data pieces is captured exceeds a designated distance.

10. The image processing apparatus according to claim 9, wherein
the at least one processor is further configured to execute the instructions to acquire an acceleration measured by the sensor included in the imaging apparatus, and identify the moving distance based on the acceleration.

11. The image processing apparatus according to claim 10, wherein
the designated distance is calculated based on the image quality of the still image represented by the still image data piece for image processing selected last time.

12. The processing apparatus according to claim 11, wherein
when the image quality of the still image data piece for image processing selected last time is better than a predetermined image quality, a distance longer than that when the image quality of the still image represented by the still image data piece for image processing selected last time is worse than the predetermined image quality is set as the designated distance.

13. The image processing apparatus according to claim 1, wherein
the reference quality includes a designated quality and a minimum quality inferior to the designated quality, and
the at least one processor is further configured to execute the instructions to select at least one still image data piece satisfying the designated quality, and when there is no still image data piece satisfying the designated quality, select at least one still image data piece satisfying the minimum quality.

14. An imaging apparatus comprising:
at least one memory storing instructions, and
at least one processor configured to execute the instructions to;
generate moving image data;
measure rotation information related to a rotation of imaging means for generating moving image data; and
transmit the moving image data associated with the rotation information to an image processing apparatus, the image processing apparatus being configured to select a still image data piece for image processing to be used for image processing according to a predetermined condition from among a plurality of still images converted from the moving image data.

15. The image processing apparatus according to claim 14, wherein
the at least one processor is further configured to execute the instructions to transmit the moving image data associated with at least one of timer information indicating a time when the moving image data is captured and a moving distance of the imaging apparatus.

16.-17. (canceled)

18. An image processing method comprising:
converting moving image data generated in an imaging apparatus into a plurality of still image data pieces;
calculating an image quality of each still image represented by one of the plurality of still image data pieces; and
selecting a still image data piece for image processing to be used for image processing from among the plurality of still image data pieces based on the image quality, wherein
in the selecting, at least one or more still image data pieces satisfying a reference quality is selected as the still image data piece(s) for image processing from among the plurality of still image data pieces arranged in an order of captured time and included in the still image data pieces from the still image data piece selected last time to a first still image data piece if it is determined that a rotation angle of the imaging apparatus when the first still image data piece included in the plurality of still image data pieces is captured exceeds a designated angle.

19. A non-transitory computer readable medium storing a program for causing a computer to execute:
converting moving image data generated in an imaging apparatus into a plurality of still image data pieces;
calculating an image quality of each still image represented by one of the plurality of still image data pieces; and
selecting a still image data piece for image processing to be used for image processing from among the plurality of still image data pieces based on the image quality, wherein
in the selecting, at least one or more still image data pieces satisfying a reference quality is selected as the still image data piece(s) for image processing from among the plurality of still image data pieces arranged in an order of captured time and included in the still image data pieces from the still image data piece selected last time to a first still image data piece if it is determined that a rotation angle of the imaging apparatus when the first still image data piece included in the plurality of still image data pieces is captured exceeds a designated angle.
